(19) United States
(12) Patent Application Publication
(10) Pub. No.: US 2016/0304025 A1
(43) Pub. Date: Oct. 20, 2016

(54) AUTOMOTIVE LIGHTING REFLECTOR SYSTEM WITH INTEGRATED SOLAR COLLECTOR

(71) Applicant: Valeo North America, Inc., Seymour, IN (US)

(72) Inventor: Robert Lee King, Seymour, IN (US)

(21) Appl. No.: 14/686,128

(22) Filed: Apr. 14, 2015

(51) Int. Cl. B60Q 1/00; F21V 13/04; F21V 8/00; F24J 2/54

(52) U.S. Cl. CPC B60Q 1/0017; F24J 2/54; F21V 13/04; G02B 6/0096

(57) ABSTRACT

A dual-purpose headlight for a vehicle. In one mode of operation, a reflector receives light from at least one light source, such as a light-emitting diode (LED), and projects the light as a headlight for the vehicle. In another mode of operation, the reflector is used to collect sunlight and reflect the collected sunlight to a solar cell to generate electricity which is stored. In one embodiment, a relative position of the reflector to the solar cell or the light source may be changed during the modes of operation.

### BACKGROUND OF THE INVENTION

1. Field of the Invention

The invention concerns lighting and/or signaling devices for vehicles, and more particularly, a lighting and/or lighting system having an integrated solar cell.

2. Description of the Related Art

In recent times, solar cells have become increasingly used to convert sunlight into electrical energy. Some argue that this reduces a user's carbon footprint because it reduces the use of fossil fuels. Some prior art vehicles used solar cells and a few of these will now be described.

One prior art lighting or signaling device is known from Japanese patent number JPS5953243 issued to Sanyo Electric Co. for a Headlamp for Vehicle that utilizes a solar battery as its power source by enabling the switching between the daytime charging of power from the solar battery to a secondary battery and the nighttime feeding of power to the headlamp to be made by means of a raised and recessed part in a headlamp housing.

Another prior art lighting or signaling device is known from Netherland Patent number NL8501060 issued to T.I. Raleigh for a Bicycle Headlamp with Inbuilt Solar Cells that consists of a housing with a transparent upper part over a built-in reflector.

Still another prior art lighting or signaling device is known from Korean Patent number KR100534885 issued to Hyundai Motor Company for a Cooling System of Head Lamp for Automobile that includes the cooling apparatus of a head lamp for an automobile powered by a solar cell in order to cool the inside of the headlamp.

Yet another prior art lighting or signaling device is known from Chinese Patent number CN201833943 issued to Wuxi LED Trust Photonic Tech for an LED (light-emitting diode) daytime driving lamp which can be used as a signal lamp in the daytime and has a solar cell module that is arranged between sections of the LED and is fixed on a flexible circuit board for matching with a storage battery of an automobile to supply power.

Still another prior art lighting or signaling device is known from German Patent number DE202005019613 for a Solar Headlamp for Vehicles that comprises a solar cell arranged in the headlamp behind external glass.

What is needed, therefore, is an improved application of the solar cell to a lighting and/or signaling device for a motor vehicle.

### SUMMARY OF THE INVENTION

In one aspect, one embodiment comprises a lighting and solar collector system for a vehicle comprising a light source, a solar cell, and a reflector which operates in a projection mode to receive light from said light source and reflect light externally from the vehicle, and operates in a collection mode to receive sunlight from the sun and direct said sunlight to said solar cell, wherein said reflector comprises at least one reflective surface, said at least one reflective surface being adapted to be movable to a first position during said projection mode and a second position during said collection mode.

In another aspect, one embodiment comprises a lighting system for a vehicle comprising a housing having a lens, a heat sink, a solar collector located on said heat sink at a first location, a light source located on said heat sink at a second location, a reflector, and an actuator for driving at least one of said reflector, said solar collector or said light source to at least one of a first configuration which causes sunlight to be directed to said solar collector, and a second configuration which causes light from said light source to be emitted from said housing through said lens to produce a headlight beam.

This invention, including all embodiments shown and described herein, could be used alone or together and/or in combination with one or more of the features covered by one or more of the following list of features:

The lighting and solar collector system wherein the solar cell generates more electricity than the light source consumes when energized.

The lighting and solar collector system wherein the light source is at least partially powered by the solar cell.

The lighting and solar collector system wherein the lighting and solar collector system further comprises an actuator adapted to move the at least one reflective surface from a first position to a second position.

The lighting and solar collector system wherein the lighting and solar collector system further comprises a heat sink for supporting and dissipating heat from both the solar cell and the light source.

The lighting and solar collector system wherein the light source comprises at least one solid state light, such as a light-emitting diode (LED).

The lighting and solar collector system wherein the lighting and solar collector system further comprises a printed circuit board and the light source is mounted on the printed circuit board.

The lighting and solar collector system where the the light source is mounted directly on the heat sink.

The lighting and solar collector system wherein during the collection mode, the light source is not energized and the at least one reflective surface is driven by an actuator to cause the at least one reflective surface to reflect the sunlight towards the solar cell.

The lighting and solar collector system wherein the at least one reflective surface comprises a first portion that is generally parabolic or lies in a generally parabolic plane and occupies the first position during the projection mode and the second position during the collection mode.

The lighting and solar collector system wherein the at least one reflective surface further comprises a second portion that is generally planar and integral with the first portion.

The lighting and solar collector system wherein the light source, the solar cell and the reflector are situated within a housing having a transparent cover lens.

The lighting and solar collector system wherein during the projection mode the reflector generates at least one of a headlight beam, a tail light beam, a signaling beam, a fog beam or a daytime running beam.

The lighting and solar collector system wherein the reflector comprises a main reflector and an auxiliary reflector coupled to or integrally formed with the main reflector.

The lighting and solar collector system wherein the auxiliary reflector reflects less than ten percent of all light reflected during the projection mode.

The lighting and solar collector system wherein the auxiliary reflector and the main reflector both direct light toward the solar cell during the collection mode.

The lighting and solar collector system wherein the system further comprises a housing having a bezel and a lens, the reflector being pivotally mounted in the housing and having a generally planar portion that defines an auxiliary reflector and that becomes generally coplanar with the bezel during the collection mode.

The lighting and solar collector system wherein the generally planar portion of the auxiliary reflector is not generally coplanar with the bezel during the projection mode and reflects at least some of the light from the light source through the lens.

The lighting and solar collector system wherein the system further comprises at least one light guide for directing sunlight to the solar cell during the collection mode and also being adapted to direct light from the light source during the projection mode.

The lighting and solar collector system wherein the at least one light guide comprises a plurality of generally elongated light guides or branches that are a generally integral, one-piece construction.

The lighting and solar collector system wherein the at least one light guide is generally Y-shaped.

The lighting and solar collector system wherein the plurality of elongated light guides or branches comprises a first branch for directing the light from the light source and a second branch for directing the sunlight to the solar cell.

The lighting and solar collector system wherein the first and second branches are configured such that the sunlight that passes through the second branch to the solar cell, first passes through at least a portion of the first branch.

The lighting and solar collector system wherein the first branch comprises at least one of a lens or a light director for directing the sunlight into the second branch.

The lighting system wherein the reflector comprises a main reflector and an auxiliary reflector coupled to or integrally formed with the main reflector.

The lighting system wherein the auxiliary reflector reflects less than ten percent of all light reflected during a projection mode.

The lighting system wherein the auxiliary reflector and the main reflector both direct light toward the solar collector during a collection mode.

The lighting system wherein the reflector is pivotally mounted in the housing, the actuator being coupled to the reflector and adapted to drive the reflector between the first configuration and the second configuration.

The lighting system wherein the system further comprises at least one light guide for directing sunlight to the solar collector during a collection mode and also being adapted to direct light from the light source during a projection mode.

The lighting system wherein the solar collector is a solar cell mounted on a printed circuit board.

These and other objects and advantages of the invention will be apparent from the following description, the accompanying drawings and the appended claims.

### BRIEF DESCRIPTION OF THE ACCOMPANYING DRAWINGS

FIGS. 1, 2, and 3 illustrate basic principles of an off-axis paraboloid reflector;

FIGS. 4A and 4B are simplified schematics of one form of the invention;

FIGS. 5 and 6 illustrate one form of the invention;

FIGS. 7 and 8 illustrate one form of the invention;

FIGS. 9 and 10 illustrate one form of the invention;

FIGS. 11, 12 and 13 illustrate one form of the invention having stationary reflectors which cooperate with the movable reflector;

FIG. 14 illustrates a vehicle containing the invention behind a headlight lens;

FIG. 15 illustrates one form of the invention that is contained within a headlight housing which is bordered by a lens;

FIGS. 16, 17, and 18 illustrate principles implemented by one form of the invention;

FIGS. 19, 20, and 21 illustrate principles implemented by one form of the invention;

FIGS. 22A-22D illustrate one form of the invention when deployed in headlight projection mode;

FIGS. 23A-23D illustrate one form of the invention when deployed in solar collection mode;

FIG. 24A is a simplification of the view of FIG. 27A;

FIG. 24B is a simplification of the view of FIG. 23A;

FIG. 25 is another simplification of the view of FIG. 22A;

FIGS. 26 and 27 illustrate the stationary solar collector;

FIG. 28 is a simplification view of FIG. 23A;

FIG. 29 is a simplification of the view of FIG. 23A;

FIGS. 30A, 30B, 31 and 32 illustrate light pipes used to implement one form of the invention;

FIGS. 33, 34, and 35 illustrate light pipes used to direct light to a solar cell and transmit light from a light-emitting diode (LED); and

FIG. 36 illustrates factors used in computing the energy content of solar radiation.

### DETAILED DESCRIPTION OF THE PREFERRED EMBODIMENTS

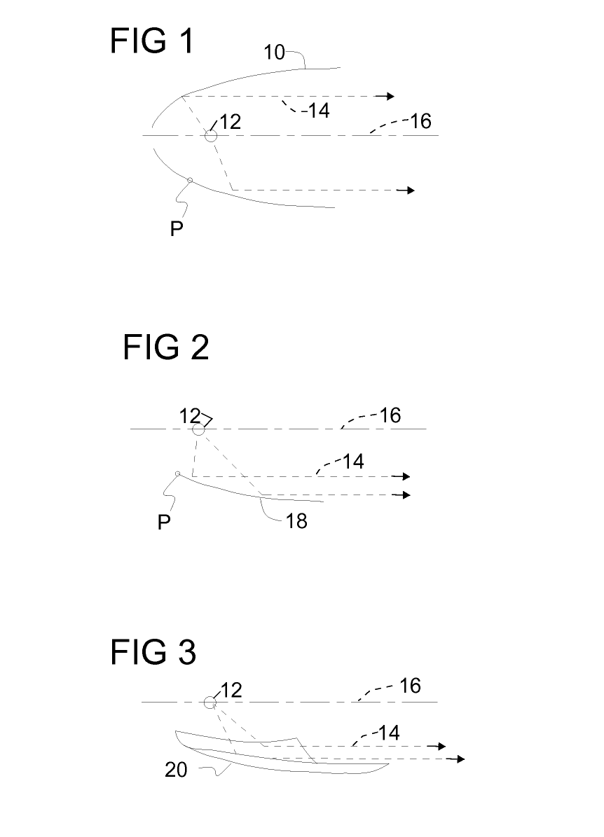

The invention concerns a lighting system for vehicles which utilizes reflectors to reflect or focus beams generated by the lighting system. The lighting system described herein may provide a low beam headlight, a high beam headlight, a tail light, a turn signal indicator, a fog light, a daytime running light or the like. Such reflectors may include an off-axis paraboloid type as explained below. FIGS. 1-3 illustrate a few basic principles of off-axis paraboloid reflectors.

FIG. 1 shows a parabolic reflector 10. Light (represented by dashed lines in the figures) which is emitted at a focus 12 of the parabolic reflector 10 is reflected by the parabolic reflector 10 and transmitted as parallel rays 14, which are generally parallel to axis 16. If the parabolic reflector 10 is cut at point P in FIG. 1, the truncated reflector 18 in FIG. 2 will result. The truncated reflector 18 still reflects light parallel to axis 16, as indicated by rays 14. Such a reflector 18 is termed “off-axis” because it is displaced from the axis 16.

FIGS. 1 and 2 illustrate parabolic reflectors in a two-dimensional geometric form. A three-dimensional reflector 20 is depicted in FIG. 3 and may take the form of a paraboloid. The parabolic reflector 20 receives light and then reflects the light generally parallel to the axis 16 as indicated. The parabolic reflector 20 of FIG. 3 is also called an off-axis paraboloid. The reflectors used by the invention may be of this type, but it should be understood that other types of reflectors can be used as well.

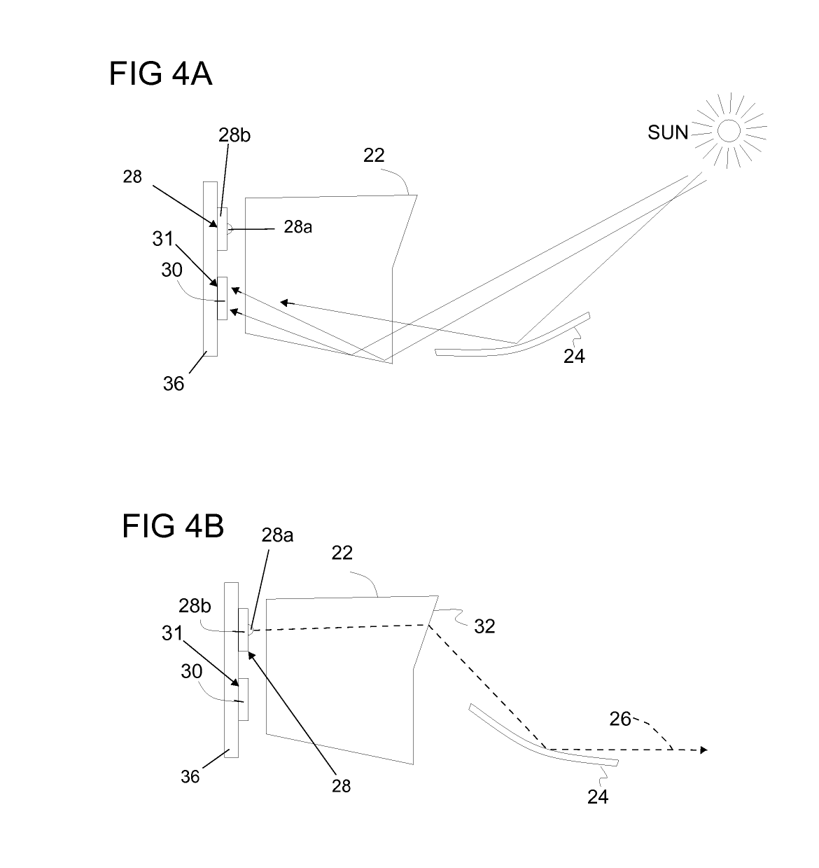

FIGS. 4A and 4B are schematic block diagrams illustrating one embodiment of the invention and its operation. An element 22 and a reflector 24 perform a two-fold function. In FIG. 4B, element 22 together with a reflector 24 acts as an optical projector during a projection mode to project a light beam 26. The light beam 26 originates from a light source 28 having at least one or a plurality of light-emitting diodes (LEDs) 28a that are mounted on a printed circuit board 28b. The light source 28 and its associated printed circuit board 28b are mounted on a heat sink 36. It should be understood that other types of light sources (i.e., other than LEDs) could be used as well. In the illustrations described herein, the light beam 26 will be presumed to be a headlight beam, but as mentioned earlier, it could be a beam that performs a different lighting function.

In FIG. 4A, element 22, together with reflector 24, also acts as a solar collector which collects sunlight and projects, reflects or directs the collected sunlight to one or more solar cells 30 to generate electrical power. The one or more solar cells 30 are also mounted on a printed circuit board 31 (FIG. 4A) of the heat sink 36. Note that during a collection mode, the reflector 24 occupies a different position in terms of location, orientation, or both in FIG. 4A when compared with FIG. 4B. In FIG. 4B and as explained later, a facet 32 may assist in refracting light toward reflector 24.

In the illustration, the solar cell 30 may be a concentrated photovoltaic (CPV) cell or a high concentrating photovoltaic cell (HCPV), but it could be other types of solar cells as well. Although only one solar cell 30 is shown in FIGS. 4A and 4B, it should be understood that more than one or an array of solar cells could be used. The solar cell 30 is coupled to a battery (not shown) which stores the electrical energy.

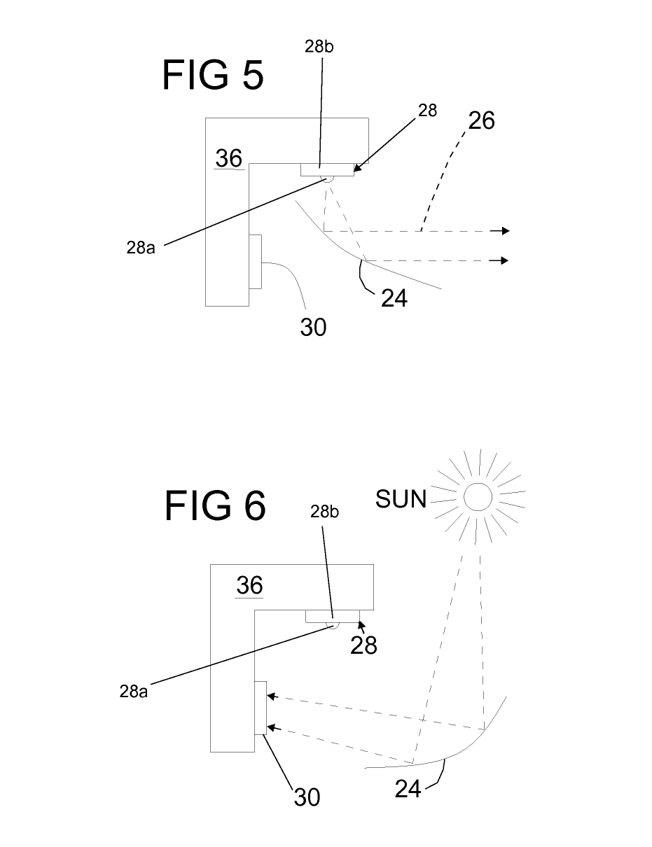

FIG. 5 is a schematic of another embodiment of the invention. In this embodiment, the heat sink 36 is generally L-shaped and the light source 28 and solar cell 30 are located thereon as described herein. The reflector 24, which may be of the off-axis paraboloid type mentioned earlier, captures light from the LED 28a and projects it as the light beam or headlight beam 26. In FIG. 6, note that the reflector 24 has been pivoted, rotated or driven from its position in FIG. 5 in order to capture sunlight and reflect the sunlight to the solar cell 30. In this embodiment, a heat sink 36 supports the light source 28 and its LED 28a and printed circuit board 28b, as well as the solar cell 30.

When the reflector 24 is operating in projection mode, as in FIG. 5, the reflector 24 may be moved to intermediate or other positions to adjust the headlight beam 26, for example, to shift between a high beam and a low beam.

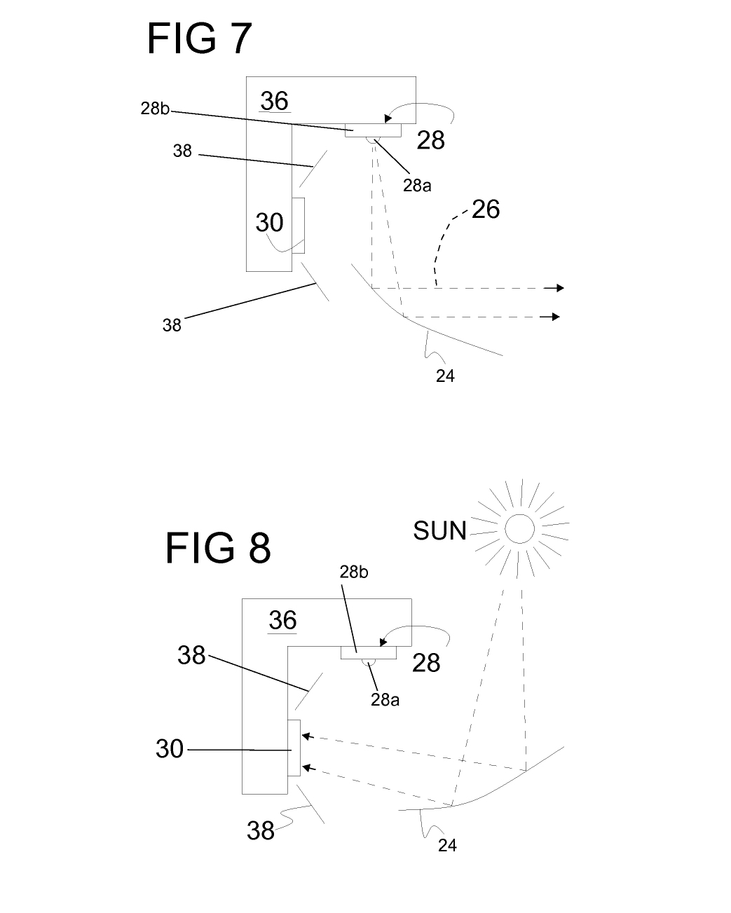

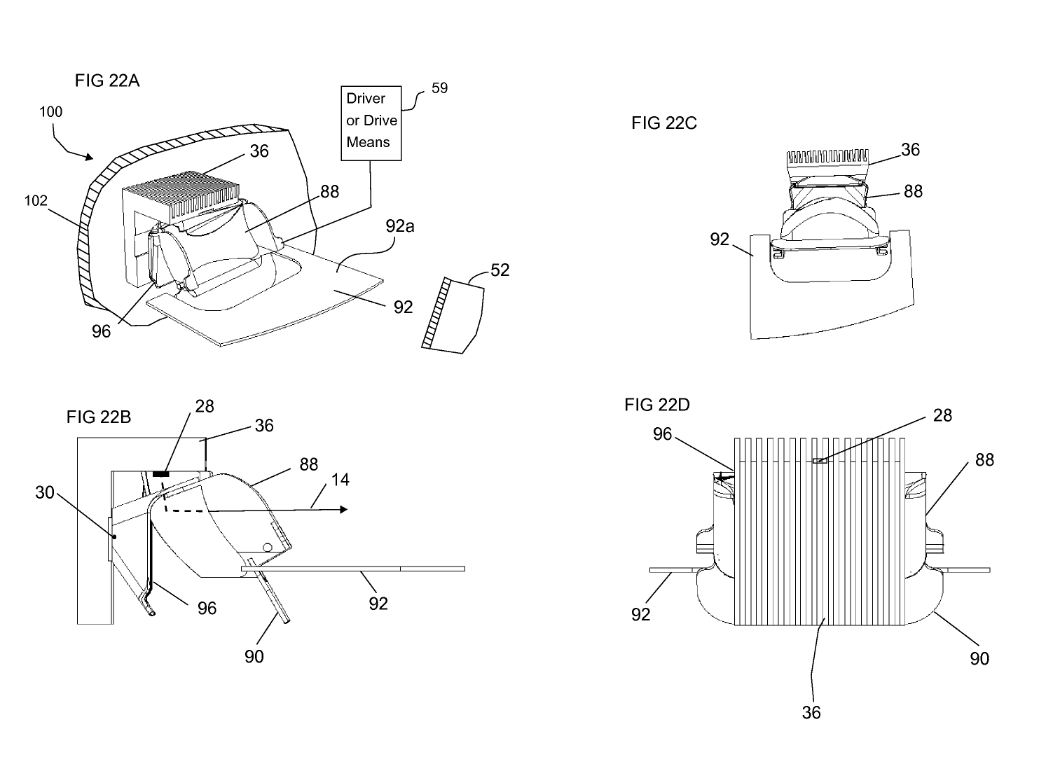

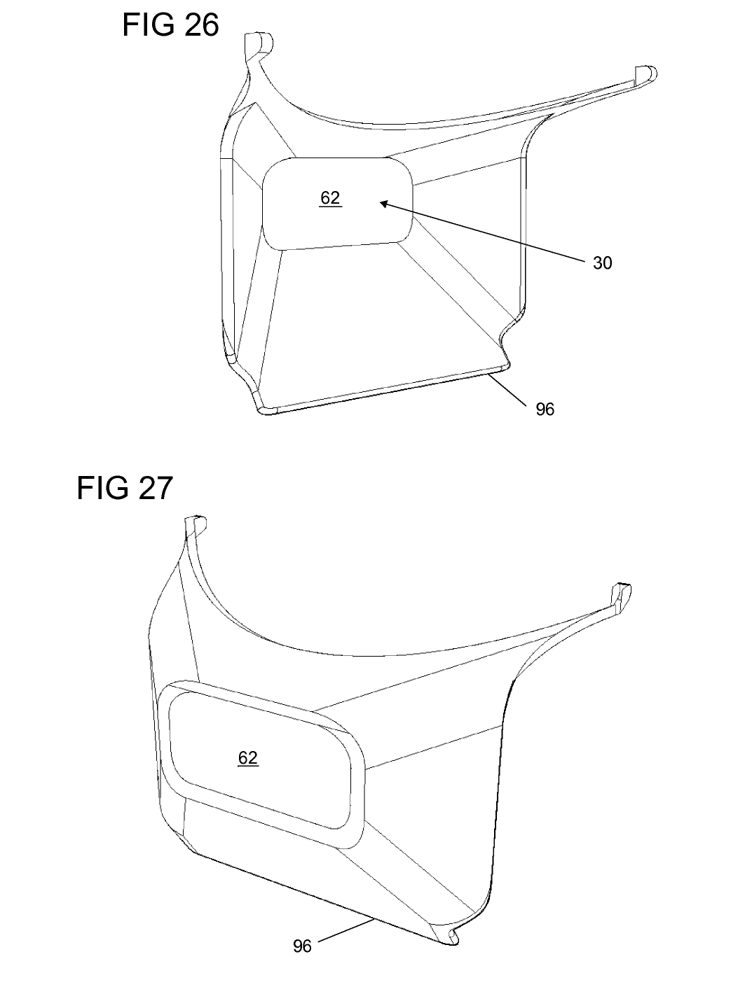

In FIG. 8, an annular reflector 38, which is labeled as part number 96 in FIGS. 22A-27, surrounds the solar cell 30 in FIG. 8 to facilitate directing light to the solar cell 30. The annular reflector 38 cooperates with the reflector 24 in collecting sunlight for the solar cell 30. Note that in FIG. 7, the reflector 24 has been pivoted, rotated or driven from a collecting position in FIG. 8 to a projection position to generate the headlight beam 26 which originates in the light source 28. In comparison, FIG. 8 shows the reflector 24 pivoted, rotated or driven to the position shown to facilitate collecting and diverting sunlight to the solar cell 30. It should be understood that in one form of the invention, the annular reflector 38 is not involved in reflecting light as part of the headlight beam 26. In other forms of the invention, the annular reflector 38 may assist in forming the headlight beam 26.

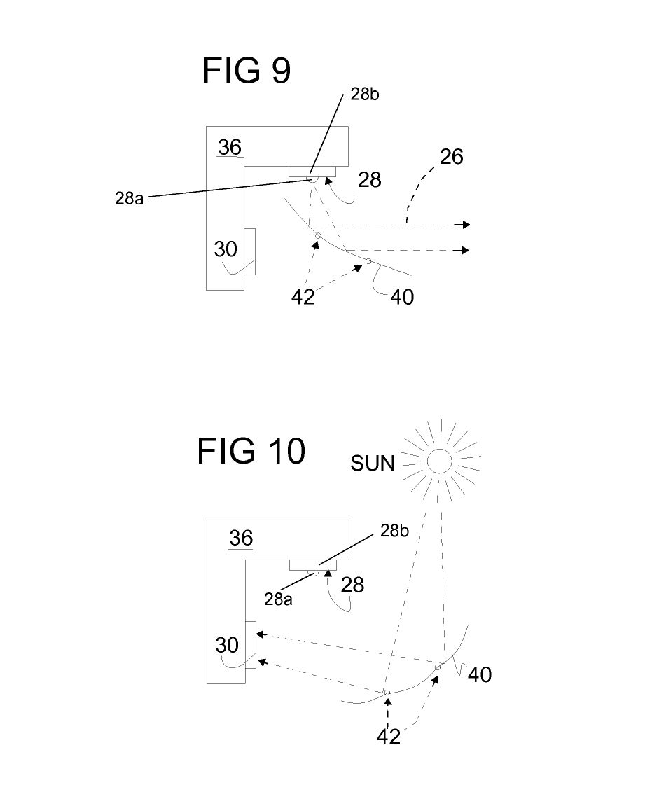

The reflectors 24 of FIGS. 5-8 have been presumed to be solid or one-piece objects, however, they may take the form of multi-segment, articulated or flexible structures. In FIG. 9, a segmented reflector 40 contains articulation points 42, or joints, analogous to a human elbow or wrist. In FIG. 9, the reflector 40 projects the headlight beam 26 which originates at the light source 28. In FIG. 10, the reflector 40 has been either (1) rotated, (2) displaced from its original position in FIG. 9, (3) bent about its articulation points 42 into a different shape, or (4) some combination of (1), (2), and/or (3) to assume a shape and position for reflecting or maximizing the reflection of sunlight to the solar cell 30.

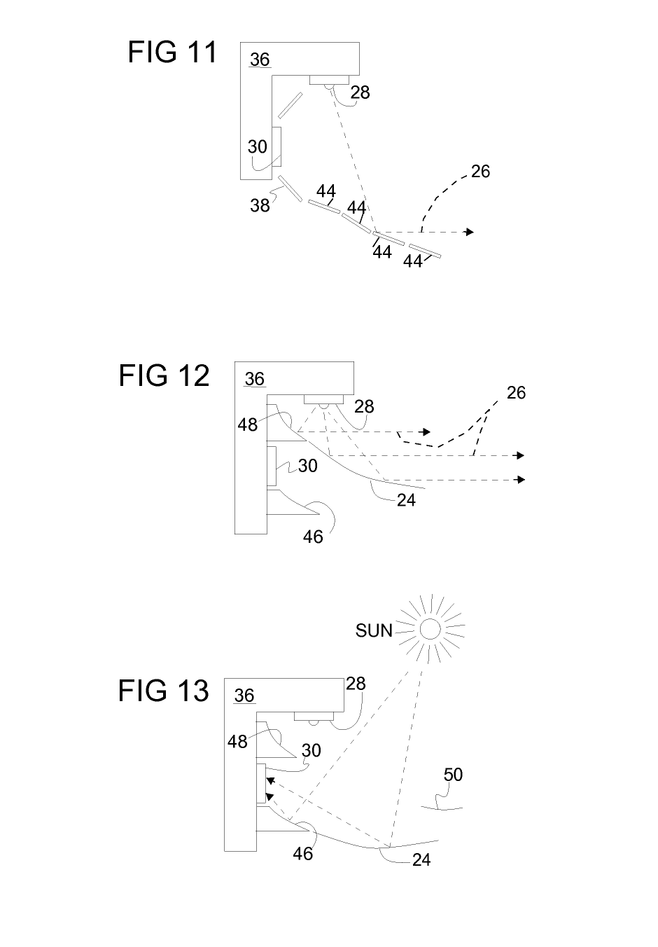

FIGS. 9 and 10 show the individual reflective segments as connected together or integrally formed. In another embodiment, the individual segments can be non-integral, non-connected to their neighbors and/or independently movable as to angle and position, as indicated by reflectors 44 in FIG. 11. It is possible that one or more of the reflectors 44 remain in a single, fixed position and do not move when the apparatus shifts from the projection mode to the light-collecting mode, while others are adapted to be moved relative to each other and relative to the solar cell 30 and light source 28.

FIG. 12 shows two stationary reflectors 46 and 48, which may be mounted to the heat sink 36 or otherwise mounted in a stationary, non-rotatable manner. In FIG. 12, stationary reflector 48 cooperates with movable reflector 24 to reflect light originating from light source 28 to form the headlight beam 26. In FIG. 13, stationary reflector 46 cooperates with movable reflector 24 to capture sunlight and transmit or reflect the sunlight to the solar cell 30. One or two additional stationary reflectors 50 in FIG. 13 at an end of reflector 24, which is opposite the end occupied by reflectors 46 and 48, may be provided to further assist the reflection functions just described. Other stationary or moveable reflectors may also be used to reflect the sunlight and to reflect light from the light source 28.

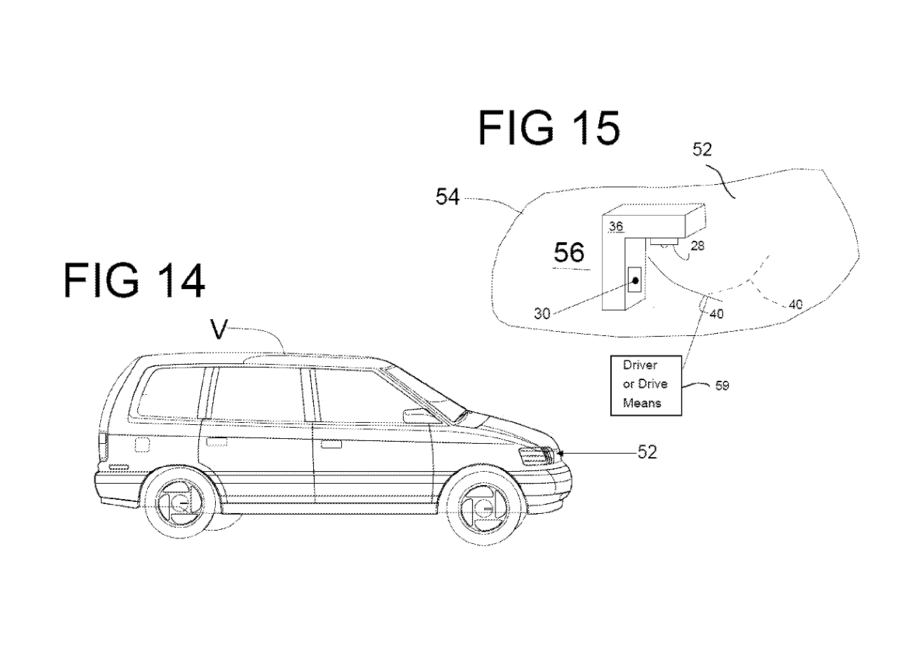

The embodiments described are primarily adapted for use in a vehicle V, as shown in FIG. 14, which contains the lighting system which is located behind a lens 52. FIG. 15 shows the lens 52 together with a housing 54 which contains one embodiment of the invention. A significant feature of one form of the invention is that the lighting system is entirely contained within a chamber 56 defined by the housing 54 and the lens 52. In one form of the invention, the lens 52 has a faired aerodynamic shape to reduce drag and to generally complement the faired shape of the vehicle V. Thus, the invention does not interfere or cause a change of any aerodynamic shape of the vehicle V.

Note in FIG. 15 that the reflector 40 is moved between a projection configuration (shown in solid line) and a solar collection figuration (shown in dashed line).

Note that no part of the solar cell 30 resides on an external surface of the vehicle V, and no part of the solar cell 30 is subject to rain, snow or other undesired conditions, such as debris. Further, no part of the solar cell 30 is subject to the wind passing the vehicle V due to the vehicle's motion, and consequently, no part of the solar cell 30 contributes to any aerodynamic drag imposed on the vehicle V.

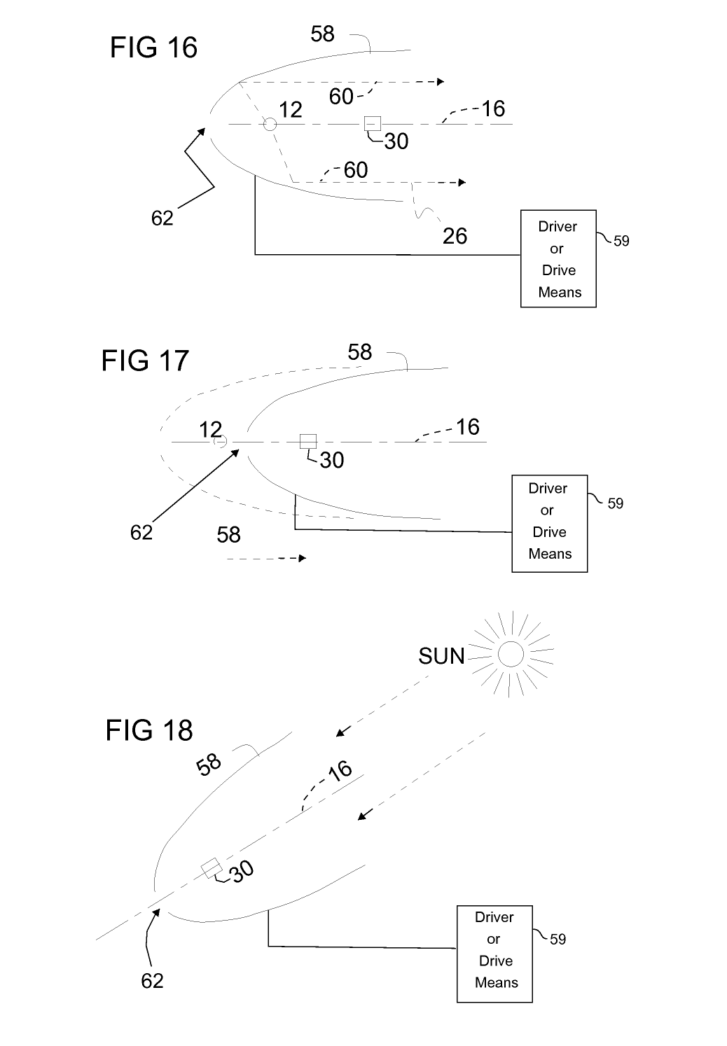

FIGS. 16-21 illustrate some principles used by some of the embodiments described herein. In FIG. 16, the light source 28 (not shown for clarity) is generally located at the focus 12 of the parabolic reflector 58. Transmitted rays 60 are parallel to the axis 16 and form the headlight beam 26. In this particular example, the parabolic reflector 58 contains an aperture 62.

In FIG. 17, the parabolic reflector 58 has moved with respect to the solar cell 30 from its former position of FIG. 16, which is shown in phantom in FIG. 17, to the solid-line position in FIG. 17. This results in the solar cell 30 being located at the focus 12 so that it can receive sunlight. The light source 28 (not shown, but located at the focus 12 in FIG. 16 and now located at the phantom focus 12 in FIG. 17) has passed through the aperture 62 because of the relative movement of the reflector 58 with respect to the light source 28 and solar cell 30.

It is pointed out that the aperture 62 is present to allow clearance for the light source 28 (not shown for ease of explanation), but located at focus 12 in FIG. 16, while the reflector 58 moves to the position shown in FIG. 17. However, the aperture 62 may not be necessary because other approaches for changing a position of the reflector 58 relative to the light source 28 and solar cell 30 are provided. In some embodiments, however, it is required that the light source 28 move through such an aperture 62.

In the embodiment of FIG. 18, notice that the displaced reflector 58 is now rotated so that its axis 16 becomes suitably aligned with the rays of the sun. Those rays will be reflected and focused toward the solar cell 30. It is here pointed out that the sun's rays at earth are effectively parallel for purposes of the invention because of the large distance between the earth and the sun.

Therefore, in FIGS. 16-18, the light source 28 is initially present at the focus 12 of FIG. 16 to generate the headlight beam 26, then (1) the reflector 58 shifts in position, (2) the solar cell 30 shifts in position or (3) both (1) and (2) occur to bring the solar cell 30 to the location of the focus 12 for collection of solar energy. In the illustration shown in FIG. 18, the reflector 58 is pivoted or driven to face the sun. This will be described later herein.

In the illustration described, the system includes a driver or drive means 59 (FIGS. 16-21), which is under the operation of a controller (not shown) that is directly or indirectly coupled or linked to the reflector 58 and adapted to drive or pivot the reflector 58 in multiple positions. In one embodiment, the driver or drive means 59 may include a solenoid and linkage (not shown) for driving, pivoting or moving the reflector 58 to perform the projection and collection modes. In this embodiment, when the light source 28 is off and not energized and the reflector 58 is rotated down (as viewed in the figure) to solar collection mode. When the light source 28 is on, the solenoid is energized and causes or drives the reflector 58 to rotate to a headlamp mode to generate the light beam 26. Another method of actuation can be a rotary device (not shown) which could be an electric motor with gears (not shown) to move the reflector 58 to the projection and collection mode positions.

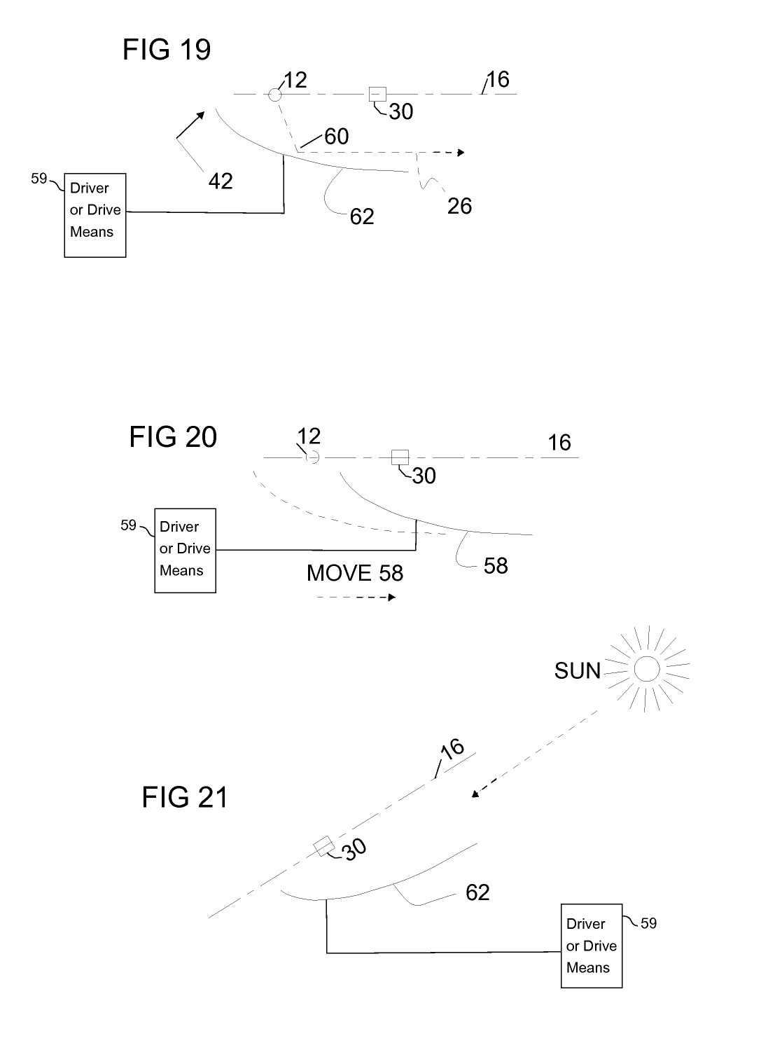

The principles of FIGS. 16-18 apply as well when the parabolic reflector 58 is truncated as in FIGS. 19-21. FIG. 19 shows a truncated off-axis reflector 62 projecting or reflecting the headlight beam 26. The light source 28 is not shown for ease of illustration, but is located at the focus 12. FIG. 20 shows the reflector 58 shifted with respect to the solar cell 30 analogous to the shifting of FIG. 17. FIG. 21 shows the reflector 62 now pivoted or rotated to point at the sun analogous to FIG. 18.

Therefore, FIGS. 16-21 illustrate, in simplified form, operations undertaken in one form of the invention. In the projection mode of operation, the light source 28 is positioned at the focus 12 to thereby project the headlight beam 26, as illustrated in FIG. 19. In the collection mode of operation, the solar cell 30 replaces the light source 28 at the focus 12 and the reflector 62 is pointed toward the sun (FIG. 21) to illuminate the solar cell 30 which, in turn, generates electrical energy. As alluded to earlier, the shape of the reflector, such as reflectors 24, 40, 58 and 62, may change from one mode to the other to thereby change a relative position or location of the focus 12 with respect to the reflector, the light source 28 or the solar cell 30. Alternatively, the positions of at least one or both of the light source 28 and the solar cell 30 may be changed relative to the reflector 24, 40, 58 or 62.

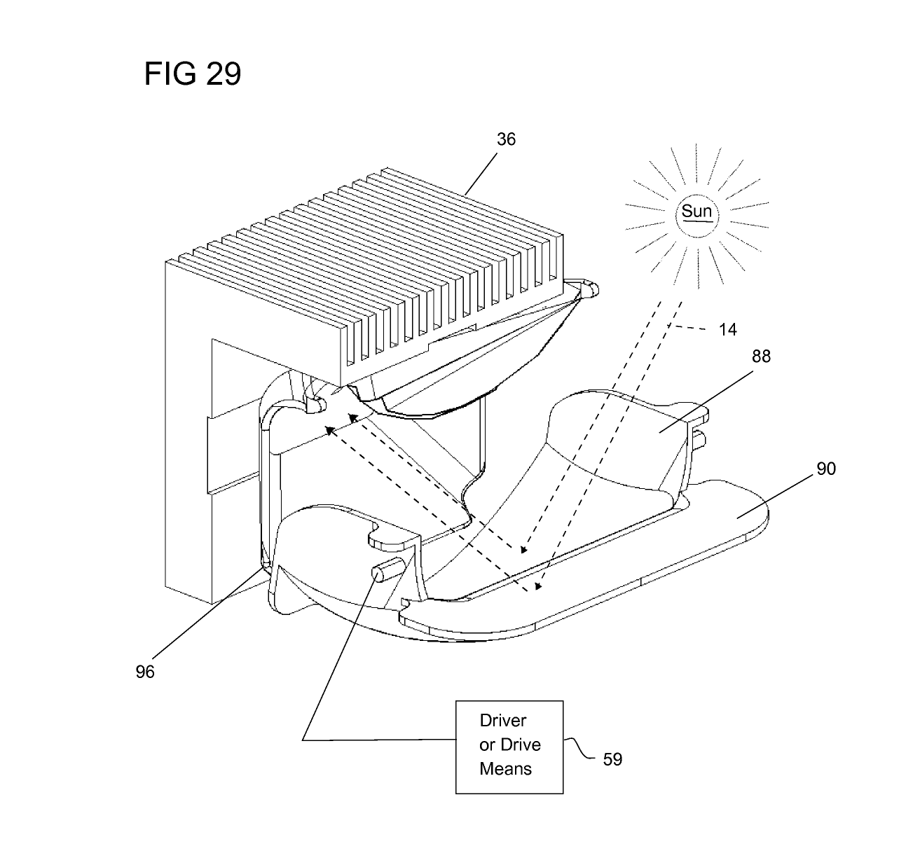

FIGS. 22A-29 are detailed drawings of another illustrative embodiment of a lighting system or assembly 100 (FIG. 22A). In this embodiment, like parts will have the same part numbers as those of previous embodiments. The lighting system or assembly 100 comprises a housing 102 that supports and houses the various components of the lighting system or assembly 100. These components include the heat sink 36 that supports both the light source 28 and solar cell 30 of FIG. 5. For ease of description and understanding, the housing 102 and lens 52 are only shown in fragmentary form in FIG. 22A, but it should be understood that all embodiments described herein also have these components.

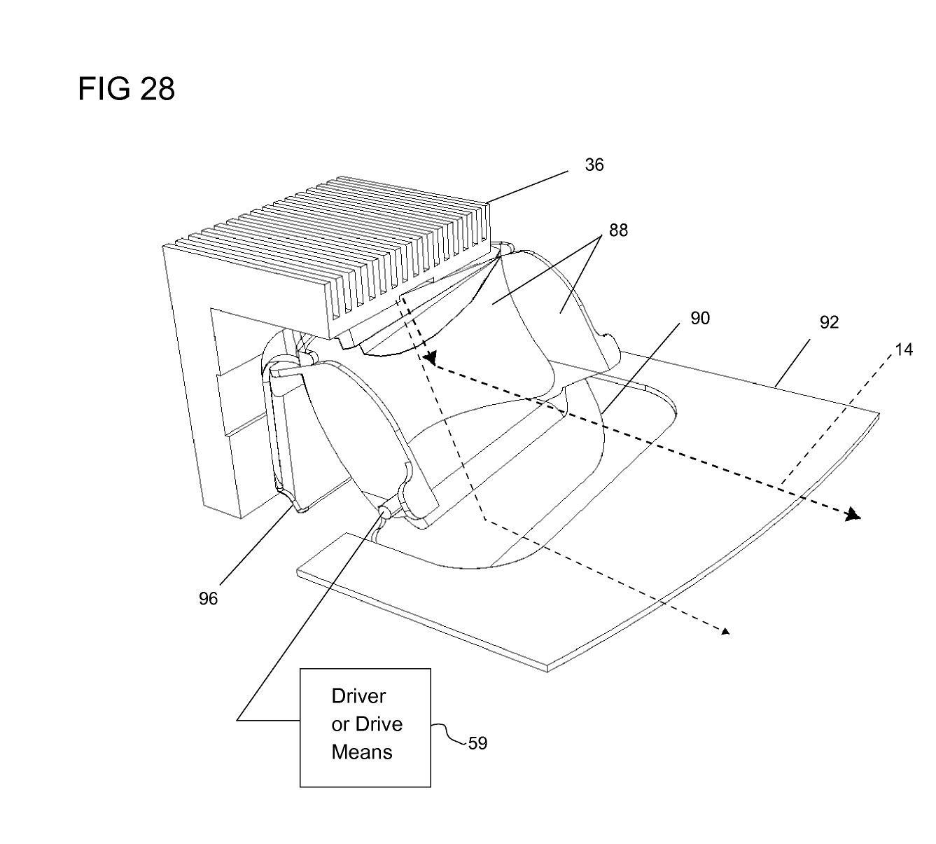

In FIG. 28, a main reflector 88 and an auxiliary reflector 90 cooperate to project the headlight beam 14 to provide the projection mode. A bezel 92 is mounted in the housing 102 and provides mechanical support for some or all of the components shown. In the illustration, a surface 92a (FIG. 22A) of the bezel 92 may have a reflective or metalized coating for contributing to the projection mode and/or collection mode. In one form of the invention, auxiliary reflector 90 in FIGS. 22A and 28 is integrally formed with the main reflector 88 and reflects rays 14 (FIG. 28) below the bezel 92 and the main reflector 88 reflects headlight rays 14 above the bezel 92. It should be understood that the driver or drive means 59 is coupled to both the main reflector 88 and the auxiliary reflector 90 and simultaneously drives them to and between the projecting position (shown in FIGS. 5, 22A-22D, 25 and 28) to the solar cell 30 sunlight collection position shown in FIGS. 6 and 23A-23D, 24A-24B and 29.

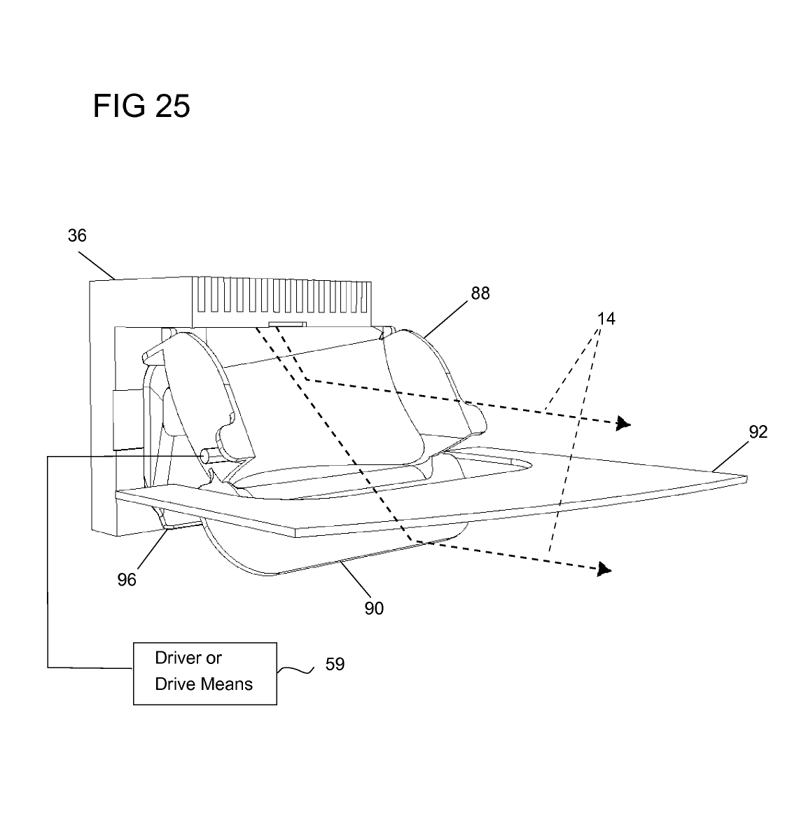

FIGS. 22A-22D are a rendition of the assembly shown in FIGS. 25-28. It is pointed out that the auxiliary reflector 90, as especially shown in the side view in FIG. 22B, is not necessarily always involved in reflecting the headlight rays. Instead, reflector 90 is used in collecting and reflecting sunlight as explained and shown relative to FIGS. 5, 22A-22D, 25 and 28. It may be difficult to prevent the auxiliary reflector 90 from reflecting no light whatsoever because stray light will be present at many locations. However, in one form of the invention, the auxiliary reflector 90 will reflect less than ten percent of the intensity of the overall headlight beam projected by the main reflector 88 and preferably less than five percent during the projection mode. As mentioned earlier, the invention is not limited to generating headlights, but can generate other types of vehicle lighting, such as tail lights, signaling lights, daytime running lights, fog lights, marker lights, and other types of lighting and/or signaling devices.

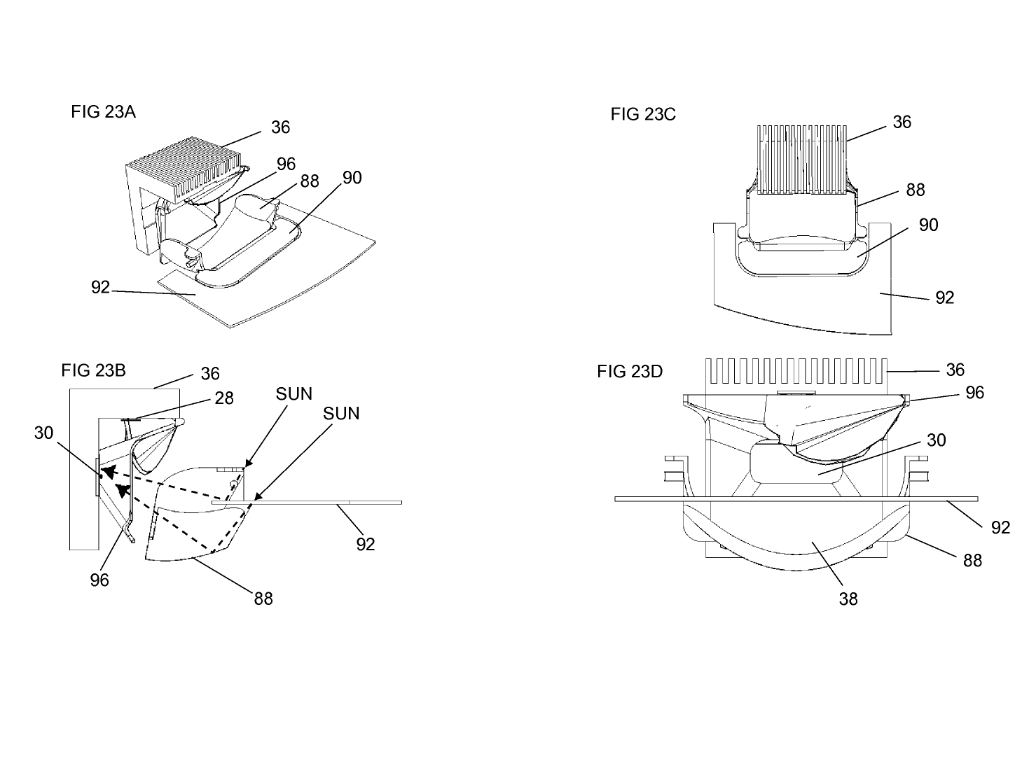

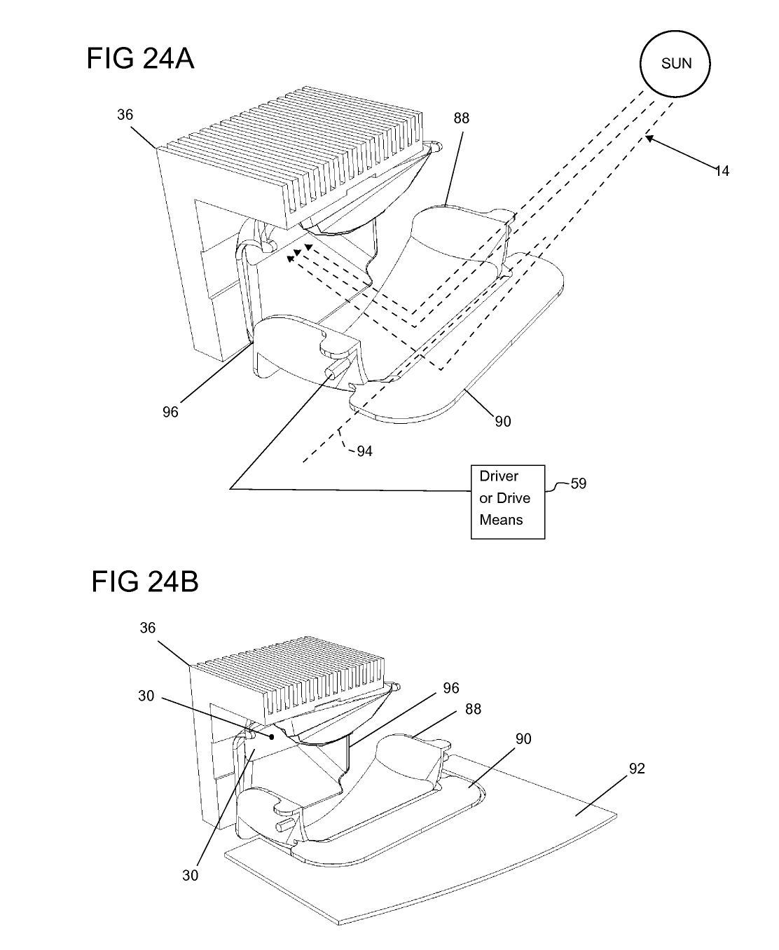

FIGS. 23A-23D, 24A-24B and 29 are detailed drawings of one form of the invention configured in the solar collection mode. The main reflector 88, together with auxiliary collector 90, collects sunlight and reflects it toward the solar cell 30. In one embodiment, the auxiliary reflector 90 is generally planar and lies in the same plane as the bezel 92 during the collection mode. Alternatively, the auxiliary reflector 90 may be hingeably coupled to the main reflector 88 along an axis 94 in FIG. 24A. In one embodiment, the lighting system or assembly 100 may include a stationary collector or reflector 96 (FIGS. 23A-23D, 26 and 27) that is similar to the annular reflector 38 in FIG. 8 and that may be used to facilitate directing light to the solar cell 30.

In one form of the invention, operation is restricted to either (1) headlight generation as in FIGS. 5, 22A-22D, 25 and 28 or (2) sunlight collection, as in FIGS. 6, 23A-23D, 24A-24B and 28, but not both headlight generation and sunlight collection simultaneously. One reason is that the reflector 88 in FIGS. 22A-22D, when transmitting a headlight, blocks sunlight from reaching the solar cell 30 at that time.

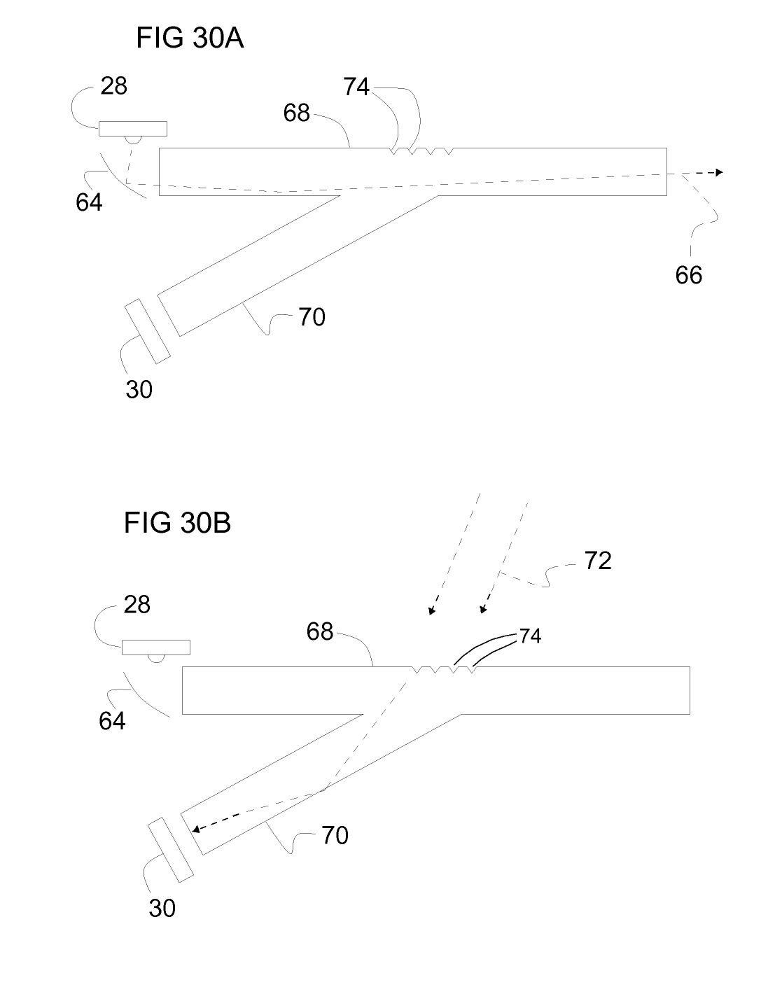

In some embodiments, light pipes or light guides may be incorporated into the housing 102 in the various forms of the lighting device. In FIG. 30A, the light source 28 projects light to a reflector 64 which projects or reflects light rays 66 along a light guide 68. The light rays 66 represent a headlight beam in the example. In an alternate arrangement, the reflector 64 can be eliminated and the light source 28 can project light directly into the light guide 68.

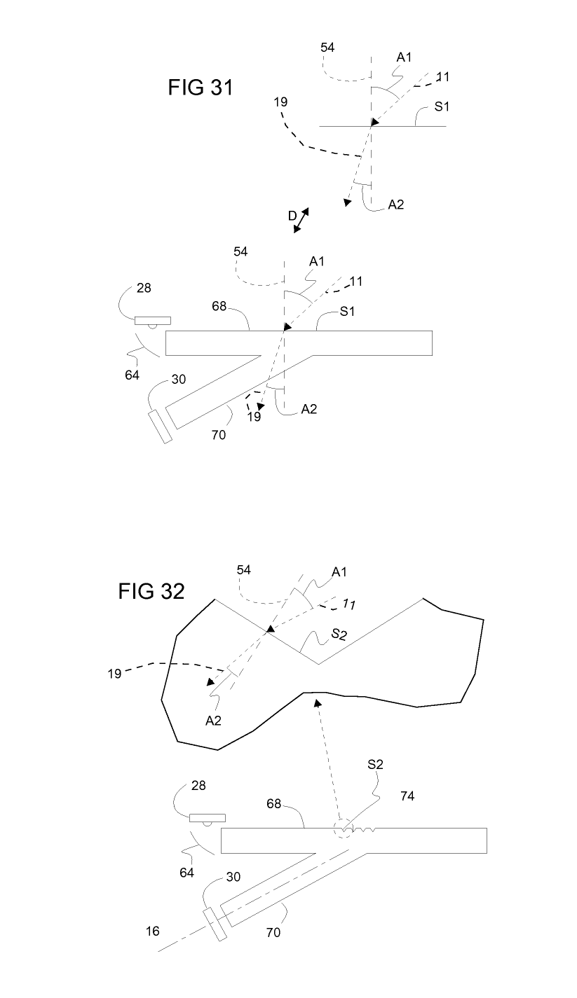

In FIG. 30B, a branch 70 of the light guide 68 transmits sunlight 72 to the solar cell 30. V-shaped grooves 74 in FIG. 30A refract the sunlight 72 in FIG. 30B so that the sunlight 72 assumes a more favorable angle for transmission through the branch 70, as FIGS. 31 and 32 will explain.

FIG. 31, bottom left, shows sunlight arriving as ray 11. Note that the grooves 74 in the light guide 68 of FIG. 30A are absent from FIG. 31. Because the light guide 68 in FIG. 31 has a higher index of refraction than the external air, the ray 11 will be bent toward the surface normal N after ray 11 passes surface S1, as indicated by ray 19. That is, angle A2 is smaller than angle A1. The rays 11 and 19 and the surface normal N are duplicated at the upper right part of the FIG. 31, as indicated by the double arrow D, for comparison with a similar plot in FIG. 32, which is explained immediately below. In FIG. 32, angle A2 is not necessarily optimal for launching light ray 11 into the branch 70. Consequently, FIG. 32 adds the grooves 74, which are also shown in FIG. 30B, to correct this situation.

In FIG. 32, one surface of one of the grooves 74 is labeled as surface S2 and is copied into the plot at the top of FIG. 32. Incoming ray 11 in FIG. 32, originating from the sun, has the same absolute angle or direction as in FIG. 31. That is, ray 11 in FIG. 31 is parallel with ray 11 in FIG. 32. However, ray 11 now encounters surface S2 in FIG. 32 instead of the top surface S1 of the light guide 68 in FIG. 31. Because surface S2 in FIG. 32 has been rotated clockwise (as viewed in the figure), compared with surface S1 in FIG. 31, ray 19 in FIG. 32 is also rotated clockwise with respect to ray 19 in FIG. 31. From one perspective, ray 19 in FIG. 32 is closer to parallel with branch 70 compared with ray 19 in FIG. 31. The ray 19 thus acquires a more favorable entry angle to the branch 70 because of the grooves 74 in FIG. 32.

A mirror (not shown) or prism could also accomplish the clockwise rotation of ray 19, but the approach of FIG. 32 is seen as simpler because it requires no added components. The grooves 74 act somewhat as a Fresnel lens.

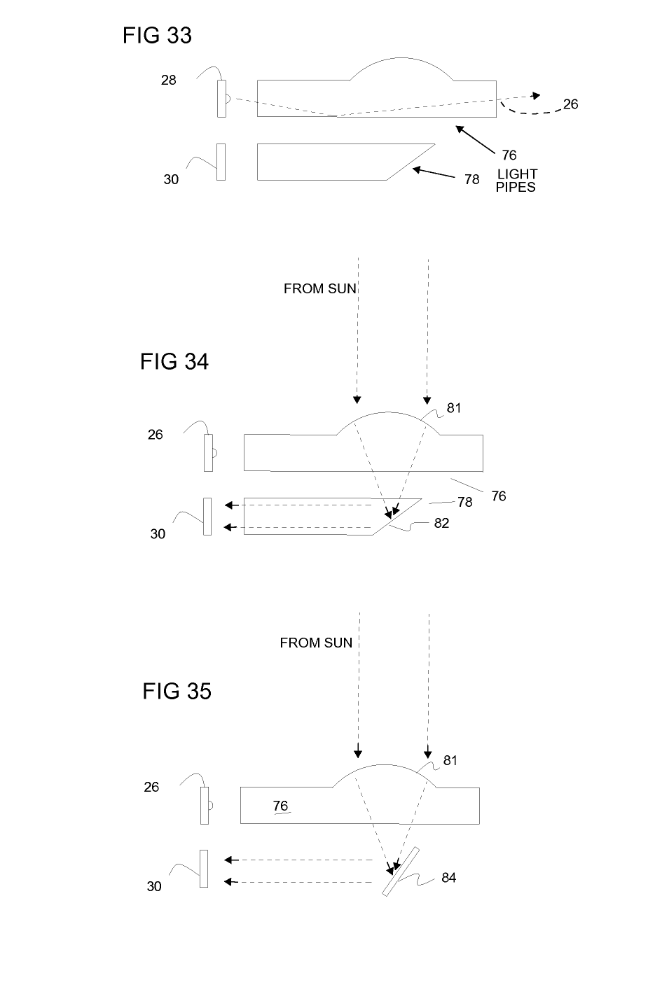

FIGS. 33-35 illustrate another form of the invention. In FIG. 33, two optical light pipes or light guides 76 and 78 are shown. The light guide 76 receives light from the light source 28 and projects the light as the headlight beam 26.

In FIG. 34, a lens 81 is integrally formed into the light guide 76 and focuses light from the sun onto a facet 82 of the light guide 78. That light is reflected toward the solar cell 30.

In another embodiment (not shown), the light guide 78 could be positioned above the light guide 78 and the lens 81 positioned on the light guide 80, which is now located above the upper light guide 76 which projects the headlight beam 26. In this embodiment, the sunlight does not pass through the light guide 78 used to generate the headlight beam 26 of FIG. 33.

In FIG. 35, the light guide 78 of FIG. 34 is replaced by a mirror 84 which reflects sunlight to the solar cell 30.

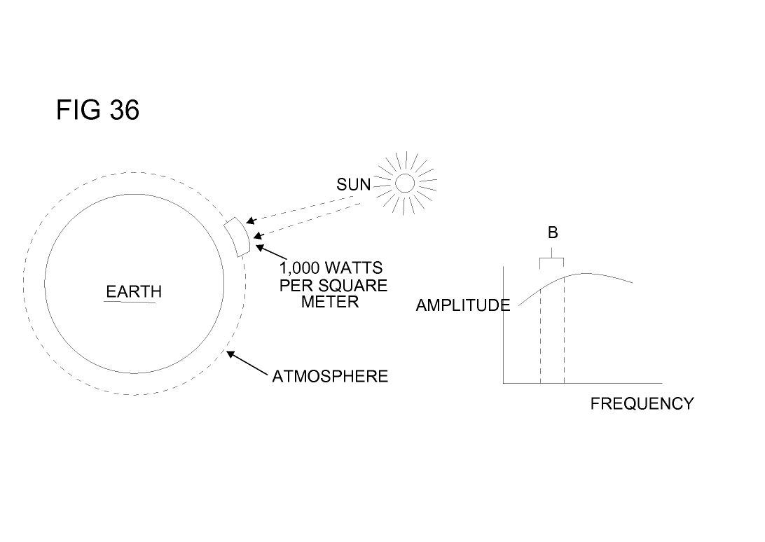

Estimates will be given of the amount of electrical power which the invention can collect from sunlight. FIG. 36 shows the earth. The dashed circle represents the atmosphere. A parameter known as the solar constant indicates the amount of energy present in sunlight which arrives at the outer limits of the atmosphere. The solar constant is roughly 1,350 watts per square meter and this value resides outside the atmosphere.

The atmosphere attenuates this energy by absorption, reflection by clouds and dust, and other mechanisms. These attenuations are commonly taken as reducing the energy by roughly fifty percent, thereby giving an energy content of about 675 watts per square meter reaching the surface of the earth. Of course, this value is not constant, but changes from season to season and from sunrise to sunset and so on.

In addition, the solar energy is distributed in multiple frequencies, as roughly indicated in the plot of FIG. 36. That plot is a simplification of the actual energy distribution in sunlight, and the latter actual distribution is commonly taken as equal to the black body radiation of a body having the surface temperature of the sun.

The distribution of the Figure is simplified because it is merely used to illustrate the fact that solar cells under present technology cannot convert all of the frequencies into electrical energy. Only a band B of the frequencies can be so converted. Further, those frequencies in band B cannot be converted with 100 percent efficiency because of technical factors inherent in the design of solar cells, which are not discussed herein.

Against this background, and making certain assumptions about these background factors, one can estimate the energy recoverable by the solar cell 30 of the invention. For example, if one further assumes that (1) the reflector 24 in FIG. 6 has an area of 50,000 square millimeters (based on dimensions of 250 mm×200 mm) and (2) the solar cell 30 has an area of 1,000 square millimeters, then one may conclude that the solar cell 30 will produce, for example, 42 watts in bright sunlight.

As a point of reference, a common type of light source 28 in FIG. 6 can consume 10 watts during daylight and 20 watts at night when it is run at higher power. Therefore, under the estimates given above, one form of the invention can recover more energy from sunlight than the light source 28 expends. For example, if the vehicle V in FIG. 11 operates on average for one hour per day during daylight and one-half hour per day at night, then the light sources 28 will consume 20 watt-hours, on average, each day. (That is, 10 watts×1 hour+20 watts×½ hour=20 watt-hours.) Operation of the solar cell for one hour, under the estimates given above, will recover twice that expenditure of power.

Advantageously, the electricity generated by the solar cell 30 will contribute to the electricity requirements of the vehicle V. This, in turn, will relieve the electrical output requirements of the alternator and battery or batteries used. The electrical energy created can be used, for example, to recharge the vehicle's battery or batteries, which saves in gasoline mileage costs. One estimation is that the charging from the solar cell 30 could provide an equivalent of approximately 250 free miles per year.

This invention, including all embodiments shown and described herein, could be used alone or together and/or in combination with one or more of the features covered by one or more of the claims set forth herein, including but not limited to one or more of the features or steps mentioned in the Summary of the Invention and the claims.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting and solar collector system for a vehicle comprising:
a) a light source;
b) a solar cell; and
c) a reflector which:
i) operates in a projection mode to receive light from said light source and reflect light externally from the vehicle; and
ii) operates in a collection mode to receive sunlight from the sun and direct said sunlight to said solar cell;
wherein said reflector comprises at least one reflective surface, said at least one reflective surface being adapted to be movable to a first position during said projection mode and a second position during said collection mode.

2. The lighting and solar collector system according to claim 1, wherein said lighting and solar collector system further comprises a heat sink for supporting and dissipating heat from both said solar cell and said light source.

3. The lighting and solar collector system according to claim 1, wherein during said collection mode, said light source is not energized and said at least one reflective surface is driven by an actuator to cause said at least one reflective surface to reflect said sunlight towards said solar cell.

4. The lighting and solar collector system according to claim 1, wherein said at least one reflective surface comprises a first portion that is generally parabolic or lies in a generally parabolic plane and occupies said first position during said projection mode and said second position during said collection mode.

5. The lighting and solar collector system according to claim 4, wherein said at least one reflective surface further comprises a second portion that is generally planar and integral with said first portion.

6. The lighting and solar collector system according to claim 1, wherein said light source, said solar cell and said reflector are situated within a housing having a transparent cover lens.

7. The lighting and solar collector system according to claim 1, wherein during said projection mode said reflector generates at least one of a headlight beam, a tail light beam, a signaling beam, a fog beam or a daytime running beam.

8. The lighting and solar collector system according to claim 1, wherein said reflector comprises a main reflector and an auxiliary reflector coupled to or integrally formed with said main reflector.

9. The lighting and solar collector system according to claim 8, wherein said auxiliary reflector reflects less than ten percent of all light reflected during said projection mode.

10. The lighting and solar collector system according to claim 8, wherein said auxiliary reflector and said main reflector both direct light toward said solar cell during said collection mode.

11. The lighting and solar collector system according to claim 1, wherein said system further comprises a housing having a bezel and a lens, said reflector being pivotally mounted in said housing and having a generally planar portion that defines an auxiliary reflector and that becomes generally coplanar with said bezel during said collection mode.

12. The lighting and solar collector system according to claim 11, wherein said generally planar portion of said auxiliary reflector is not generally coplanar with said bezel during said projection mode and reflects at least some of said light from said light source through said lens.

13. The lighting and solar collector system according to claim 1, wherein said system further comprises at least one light guide for directing sunlight to said solar cell during said collection mode and also being adapted to direct light from said light source during said projection mode.

14. The lighting and solar collector system according to claim 1, wherein system further comprises a plurality of elongated light guides or branches that comprises a first branch for directing said light from said light source and a second branch for directing said sunlight to said solar cell.

15. A lighting system for a vehicle comprising:
a housing having a lens;
a heat sink;
a solar collector located on said heat sink at a first location;
a light source located on said heat sink at a second location;
a reflector; and
an actuator for driving at least one of said reflector, said solar collector or said light source to at least one of:
i) a first configuration which causes sunlight to be directed to said solar collector; and
ii) a second configuration which causes light from said light source to be emitted from said housing through said lens to produce a headlight beam.

16. The lighting system according to claim 15, wherein said reflector comprises a main reflector and an auxiliary reflector coupled to or integrally formed with said main reflector.

17. The lighting system according to claim 16, wherein said auxiliary reflector reflects less than ten percent of all light reflected during a projection mode.

18. The lighting system according to claim 17, wherein said auxiliary reflector and said main reflector both direct light toward said solar collector during a collection mode.

19. The lighting system according to claim 15, wherein said reflector is pivotally mounted in said housing, said actuator being coupled to said reflector and adapted to drive said reflector between said first configuration and said second configuration.

20. The lighting system according to claim 15, wherein said system further comprises at least one light guide for directing sunlight to said solar collector during a collection mode and also being adapted to direct light from said light source during a projection mode.
